(19) United States
(12) Patent Application Publication
(10) Pub. No.: US 2003/0003346 A1
(43) Pub. Date: Jan. 2, 2003

(54) Structure for fuel cell active electrode layer with solid polymer electrolyte

(76) Inventor: Guy Bronoel, Versailles (FR)

Correspondence Address: HENDERSON & STURM LLP, 1213 MIDLAND BUILDING, 206 SIXTH AVENUE, DES MOINES, IA, 50309-4076, US

(21) Appl. No.: 09/903,016

(22) Filed: Jul. 11, 2001

Related U.S. Application Data
(63) Continuation of application No. PCT/FR00/00084, filed on Jan. 7, 2001.

(30) Foreign Application Priority Data
Jan. 14, 1999 (FR) 99.00295

(51) Int. Cl. H01M 4/86; H01M 8/10

(52) U.S. Cl. 429/40; 429/42; 429/30

(57) ABSTRACT

The invention concerns a fuel cell electrode with solid polyer electrolyte comprising in its active layer at least two distinct domains: one is in particular the site of electronic transfer electrochemical reactions, the other serves only for ionic conduction. Said novel electrode structure for fuel cell with solid electrolyte polyer is designed the current density levels at the electrodes by increasing the thickness of the efficient part of their active layer. To achieve this, the ionic conduction in the active layer thickness is reinforced by adding, in specific content, impregnated fibres of the ionic conductor. Moreover, conditions are produced such that the surfaces comprising the platinum sites are coated with a film, uniform if possible, whereof the thickness should not exceed a predetermined value. Finally, it is optionally advantageous to place in the active layer micro-tubes which will promote the transfer of gas phases.

### CROSS-REFERENCE TO RELATED APPLICATIONS

This application is a continuation application which is being filed as the national phase of International Application No. PCT/FR00/00084 filed Jan. 7, 2001, which claims priority of French Patent Application No. 99.00295 filed Jan. 14, 1999 and is hereby incorporated herein by reference.

### BACKGROUND OF THE INVENTION

1. Field of the invention.

The present invention relates to an electrode for a solid polymer electrolyte fuel cell whose active layer includes at least two separate domains with different compositions: one is in particular the site of electron transfer electrochemical reactions, another, of fibrous structure, is dedicated exclusively to ionic conduction throughout the volume of said fibres, and a possible third domain of tubular structure serves to transfer gas species such as fuel, combustion-supporting gas, reaction products and inert substances, independently of the possible presence in the active layer of a binder such as PTFE or FEP.

2. Description of the related art.

To improve the performance of solid polymer electrolyte fuel cells and significantly reduce their cost it is essential to increase greatly the surface power density of their electrodes. This minimises the cost of the bipolar collectors and the membrane and the cost of producing the electrodes.

An in-depth analysis of the operation of electrodes currently offering the best performance shows that the thickness of the electrochemically effective layer is generally limited to 5 μm and never exceeds 10 μm. Thus the local current densities are constant only for layers very near the surface (5 μm) and then fall off strongly, to cancel out in practice beyond 10 μm. We have found that the cause of this collapse is essentially related to a local decrease in the Q, resulting from insufficient ionic conduction. However, it is well known that including an ionic conductor such as Nafion™ in the active layer of the electrode is one way to improve its performance. Thus a volume of Nafion™ representing about 33% by volume of the platinum-coated carbon present in the active layer is generally introduced into that layer. We have found that ionic conduction in this layer is from 5 to 10 times less than that calculated from the known quantity of Nafion™ introduced and its specific conductivity. This is because the layer of Nafion™ is poorly distributed because of the porosity of the structure consisting of the carbon particles; some catalyst sites are not covered by Nafion™ and there are clumps of Nafion™ elsewhere in the porous layer. This results in very discontinuous conduction, which remains possible, but only via extremely tortuous paths.

We have therefore opted to give preference to the homogeneity of the ionic conductor layer over its thickness.

### BRIEF SUMMARY OF THE INVENTION

An object of the present invention is to overcome the limitations on the thickness of the electrochemically effective layer previously cited.

According to the present invention an electrode for a solid polymer electrolyte fuel cell is provided, characterised in that its active layer includes at least two separate domains with different compositions so that one is in particular the site of electron transfer electrochemical reactions and another, of fibrous structure, is dedicated exclusively to ionic conduction. A possible third domain, of tubular structure, serves to transfer gas species such as fuel, combustion-supporting gas, reaction products and inert substances, independently of the possible presence in the active layer of a binder such as PTFE or FEP.

### DETAILED DESCRIPTION OF THE INVENTION

According to one feature of the invention, the domain which is the seat of electrochemical reactions has a microporous structure with no preferred orientation; its pores consist of interstices between particles of carbon carrying on their surface microparticles of catalyst covered with a deposit of ionic conductor whose thickness must be as uniform as possible and in the range from 50 Å to 200 Å.

It can be shown that the ionic transfers are effected well under the above conditions, provided that the domains in which they are effected are not too large. As a result, at the boundaries of these domains, ionic conduction must be reinforced by a structure rich in ionic conductors. That structure can advantageously consist of fibres impregnated with Nafion™ or another ionic conductor, if necessary. In an ideal structure substantially cylindrical fibres would be disposed in the active layer perpendicularly to the front surface of the electrode. Unfortunately, it is very difficult to achieve this kind of structure. It is therefore necessary to accept any disposition of the fibres rich in ionic conductors in the active layer. It is then a question of defining the quantity of fibres to be introduced for the increase in the ionic conduction within the thickness of the active layer to be significant. Also, it is clear that the quantity of fibres must not be too great, since that would reduce the mass of catalyst in the active layer. Accordingly, if it is accepted that the volume of the fibres must not be more than 20% of that of the carbon carrying the catalyst, and that the average diameter of a domain limited by the fibres must not be greater than 5 μm, it can be shown that under these conditions the mean diameter of the fibres must be less than 3 μm.

According to one feature of the invention, this yields well defined limits on the quantity and characteristics of the fibres used to constitute the domain of the active layer dedicated to ionic conduction. The volume occupied by the fibres impregnated by an ionic conductor is from 10% to 30% of that of the active layer and the mean diameter of the fibres can be from 0.5 μm to 5 μm and their length from 20 μm to 100 μm; these dimensions determine a continuous path over several tens of microns for the movement of the protons.

According to another feature of the invention, the material of which the fibres initially consist must have a capacity for fixing the solution in which the ionic conductor is dissolved or dispersed such that the mass in the dry state of the fixed ionic conductor is more than 70% of the initial mass of the fibres. The suitable material is either an organic substance, such as cotton or a polyester, or a mineral substance, such as silica.

Adding fibres rich in ionic conductors into the active layer limits the quantity of conductor covering the microparticles of the catalyst so that, in accordance with the invention, the volume of ionic conductor covering those particles represents only 5 to 20% of the volume of the carbon and the catalyst as a whole in the active layer, rather than 33%, the value generally used for electrodes of conventional design.

The ionic conductor is deposited on the surface of the carbon particles carrying the microparticles of the catalyst by immersing and agitating carbon particles in a solution or microdispersion of the ionic conductor in an appropriate solution or solvent, followed by slow evaporation of the liquid phase.

The electrode in accordance with the invention therefore has similarities with living organisms, which are characterised by distinct networks, by their functions and by their size: bronchioles for the transfer of gases (incoming oxygen, outgoing CO₂), network of arteries and veins for the blood, network of arteries and capillary network between them.

Given the above, and the fact that, for electrodes fed with air, limitations have been observed due to backscattering of nitrogen, the active layer can in some cases advantageously include a third domain, of tubular structure, dedicated to gas phase transfer, consisting of microtubes with walls that are permeable to gases, and in particular walls that are permeable to oxygen; the microtubes are extended into the diffusion layer. Materials developed by Gore to solve thermal insulation problems can therefore prove to be of benefit in that it is now possible to obtain tubes having an outside diameter from 1 μm to 10 μm. In all cases their length must be slightly less than the thickness of the electrode, i.e. from 100 μm to 400 μm. Once again, in order not to reduce the mass of catalyst in the electrode, the volume of the tubes in the active layer must be from 5% to 15% of the volume of the active layer. Using this method, consideration can be given to reducing the content of binder (PTFE or FEP) in the active layer.

Based on the foregoing, an oxygen electrode has been made which is characterised in that it includes electrochemically active domains in which it is necessary to make a very thin and homogeneous layer of Nafion™ and an array of fibres rich in Nafion™.

The carbon constituting the active layer was Vulcan carbon black over which was dispersed an amount of platinum representing 30% of the total mass of carbon and platinum.

The platinum-coated carbon was dispersed in a solution of Nafion™ with ultrasonic agitation; the quantity of Nafion™ (expressed as dry extract) represented 10% of the volume occupied by the carbon and the concentration of the Nafion™ solution was only 2%. After mixing for one hour, the carbon particles were removed and the solvent of the solution evaporated by heating to 95 C. for one hour.

The particles of platinum-coated carbon covered with Nafion™ were then mixed with 35% by weight of PTFE relative to the mass of carbon and a solvent in the form of a 50% mixture of water and ethanol. Fibres impregnated with Nafion™ were added to the mixture in a proportion of 30% by volume relative to the total volume of the platinum-coated carbon. The fibres, consisting initially of polyester microfibres with a mean diameter of 1.5 μm and a mean length of 50 μm, were impregnated by immersing the fibres in a solution of soluble Nafion™ to 5% net excess and then evaporated by drying at 95 C.

The mixture was then sprayed onto a substrate constituting the diffusion layer; a mass of 2.1 mg was deposited on a front surface area of 1 cm².

After drying at 95 C., the surface was sprayed again with 0.1 mg/cm² of Nafion™, the surface layer having to ensure a good bond with the membrane to be associated with it.

For comparison, another electrode of standard design was made, including: the same diffusion layer. 2.2 mg/cm² of the mixture of platinum-coated carbon+Nafion™+PTFE (of which 0.8 mg/cm² was platinum-coated carbon). For both electrodes, the mass of Pt per cm² was substantially the same. the same final layer for bonding with the membrane.

Two cells were made: they included electrodes with a front surface area of 10 cm². The hydrogen electrodes in each cell were the same, as was the membrane (Nafion™ 115). After the temperature stabilised at 80 C., and feeding O₂ and H₂ at an absolute pressure of 2 bars, the current of each cell was measured at a voltage of 0.7 V.

For the cell including a standard oxygen electrode, the overall current was 5.5A. For the cell including an oxygen electrode with the new structure the overall current was 8A.

The experiment shows clearly the benefit of producing electrochemically active domains that are relatively impoverished but homogeneous in Nafion™ and domains consisting of fibres rich in Nafion™.

Of course, far from being limited to the data of this experiment, which does not reflect ideal experimental conditions, the invention encompasses all variants thereof.

1) (Once Amended) An electrode for a solid polymer electrolyte fuel cell, characterised in that its active layer includes at least two separate domains with different compositions so that one is in particular the site of electron transfer electrochemical reactions, another, of fibrous structure, is dedicated exclusively to ionic conduction throughout the volume of said fibres, and a possible third domain, of tubular structure, serves to transfer gas species such as fuel, combustion-supporting gas, reaction products and inert substances, independently of the possible presence in the active layer of a binder such as PTFE or FEP.

5) (Once Amended) An electrode according to claim 1 for a solid polymer electrolyte fuel cell characterised in that the domain whose exclusive function is ionic conduction consists of fibres impregnated with an ionic conductor, said fibres occupy from 10%, to 30% of the volume corresponding to the whole of the active layer, the mean diameter of the fibres being from 0.5 μm to 5 μm and their length from 20 μm to 100 μm, and said dimensions determine a continuous path over several tens of microns for the movement of the protons.

6) (Once Amended) An electrode according to claim 5 for a solid polymer electrolyte fuel cell characterised in that the material of which the fibres initially consist must have a capacity for fixing the solution in which the ionic conductor is dissolved or dispersed such that the mass in the dry state of the fixed ionic conductor is more than 70% of the initial mass of the fibres.

7) (Once Amended) An electrode according to claim 1 for a solid polymer electrolyte fuel cell, characterised in that a third domain dedicated to gas phase transfer is provided, consisting of microtubes with walls that are permeable to gases, and in particular walls that are permeable to oxygen, occupying in the active layer from 5% to 15% of the volume of the active layer and having an outside diameter in the range from 1 μm to 10 μm and a length in the range from 100 μm to 400 μm.
